(19) United States
(12) Patent Application Publication
(10) Pub. No.: US 2026/0351894 A1
(43) Pub. Date: Nov. 5, 2026

(54) PROTECTIVE INSULATOR INTENDED TO BE MOUNTED ON AN ELECTRICAL CONNECTOR, AND ASSEMBLY COMPRISING SUCH PROTECTION

(71) Applicant: SAFRAN ELECTRICAL & POWER, BLAGNAC (FR)

(72) Inventors: Vincent CHAPERON, MOISSY CRAMAYEL (FR); Jean-Laurent DIEVART, MOISSY CRAMAYEL (FR); Raïs M'FUMU AMBIL, MOISSY CRAMAYEL (FR); Samir NEHME, MOISSY CRAMAYEL (FR)

(21) Appl. No.: 19/099,283

(22) PCT Filed: Jul. 28, 2023
(86) PCT No.: PCT/FR2023/051217

§ 371 Date: Jan. 28, 2025

(30) Foreign Application Priority Data
Jul. 29, 2022 (FR) FR2207927

(51) Int. Cl. H01R 13/53; B64D 47/00; H01B 17/42

(52) U.S. Cl. CPC H01R 13/53; B64D 47/00; H01B 17/42; H01R 2201/26

(57) ABSTRACT

A protective insulator intended to be fixed on an electrical connector, the electrical connector including a base, at least a first terminal and a second terminal, the protective insulator including a fixing system configured to be able to be fixed on the electrical connector in such a way as to at least partially cover the base, and an insulating separation means arranged in such a way as to completely separate the first terminal from the second terminal when the protective insulator is fixed on the electrical connector.

### TECHNICAL FIELD OF THE INVENTION

The technical field of the invention is that of electrical connections in aircraft.

The present invention relates to an insulating protection and in particular to an insulating protection for increasing length of the creepage distances in order to limit the risk of short-circuits or partial discharges.

### TECHNOLOGICAL BACKGROUND OF THE INVENTION

Electric or hybrid-propelled aircraft represent a very promising market, with significant prospects and demand for intra-and inter-urban transport of goods and people. Numerous projects are being launched on a regular basis, either by established players or by new entrants. Propulsion is performed by one or more electric motors, the number varying according to the aircraft architecture, and these electric propulsion systems use increasingly high voltage levels, which raises the problem of partial discharges at altitude.

Indeed, traditionally, connectors do not require protection because their characteristics specify the limits in terms of insulation distances. However, the use of ever-smaller connectors to carry ever-higher voltages and at higher altitudes is leading to restrictions that need to be anticipated in terms of partial discharges. In particular, the use of very high voltage levels (up to 1000V) at altitude results in partial discharge phenomena appearing more quickly than with the conventional AC or DC voltages (115 Vac/230 Vac/28 Vdc) mainly used in aeronautics.

In view of these high voltages, insulation distances (potentials/potentials and potentials/ground) have to be increased. The same applies to creepage distances between HVDC (for High Voltage Direct Current) or HVAC (for High Voltage Alternating Current) potentials. Otherwise, systems with connectors whose male or female pins are connected to a high voltage (AC or DC) may be faced with insulation distances that are too small or creepage distances (paths along the connector materials between the two potentials) that are too short, causing partial discharges to occur.

There is therefore a need to be able to adapt the connectors currently used in aeronautics to applications requiring high voltages.

### SUMMARY OF THE INVENTION

The invention provides a solution to the problems previously discussed, by providing an insulating protection which greatly reduces the risk of discharge and increases length of the creepage distance between the various connection terminals.

For this, one aspect of the invention relates to an insulating protection to be secured to an electrical connector, the electrical connector comprising a receptacle, at least a first terminal and a second terminal, the insulating protection comprising attachment means configured to be able to be secured to the electrical connector so as to at least partially cover the receptacle, and insulating separation means arranged so as to completely separate the first terminal from the second terminal when the insulating protection is secured to the electrical connector. A first electrode is said to be separated from a second electrode when no part of the first electrode faces any part of the second electrode.

By virtue of the invention, the risk of a short-circuit (or partial discharge) between the terminals of the electrical connector or between one terminal of the electrical connector and its receptacle is reduced or even eliminated. In addition, the length of the creepage distance between the terminals or between each terminal and the receptacle is increased, especially given the presence of the separation means.

Further to the characteristics just discussed in the previous paragraph, the insulating protection according to a first aspect of the invention may have one or more complementary characteristics from among the following, considered individually or according to any technically possible combination.

According to one embodiment, the attachment means and the separation means are distinct from each other.

According to one embodiment, the separation means comprises only at least one plate (that is, only plates) extending outside the hollow body from an outer surface of the apex of the hollow body. This outer surface is radial with respect to the opening in the hollow body, that is, perpendicular to an axis of a cylindrical wall in the case of a cylindrical hollow body.

According to one example, the plates comprise at least one radial free edge connecting two free surfaces and a free edge forming an apex of the plate.

In one embodiment:
the attachment means comprises a hollow body of insulating material including a first apex and a second apex opposite to the first apex and:
   at the first apex, comprising a first surface, a first opening and a second opening;
   at the second apex, a main opening;
the separation means comprises a plate of insulating material in contact with the first apex and disposed perpendicularly to the surface of this first apex between the first opening and the second opening.

According to one example, the plate of insulating material extends outwardly from the surface of the first apex in the opposite direction to the second apex.

In one embodiment, the attachment means comprises, at the first apex, a third opening and a fourth opening; and the separation means comprises a second plate of insulating material, said second plate being in contact with the first apex and disposed perpendicularly to the surface of this first apex between the first opening and the fourth opening on the one hand, the second opening and the third opening on the other hand, the first plate of insulating material being disposed between the first opening and the second opening on the one hand, the fourth opening and the third opening on the other hand.

A second aspect of the invention relates to an assembly comprising an insulating protection according to the first aspect of the invention and an electrical connector, the electrical connector including a receptacle, at least a first terminal associated with a first polarity and a second terminal associated with a second polarity different from the first polarity, the first terminal and the second terminal protruding from the receptacle, the attachment means of the insulating protection being secured to the electrical connector so as to at least partially cover the base, and the separation means of the insulating protection being arranged so as to completely separate the first terminal from the second terminal.

Further to the characteristics just discussed in the previous paragraph, the assembly according to the second aspect of the invention may have one or more complementary characteristics from among the following, considered individually or according to any technically possible combination.

In one embodiment, the electrical connector includes a third terminal associated with a third polarity different from the first and second polarities, and a fourth terminal associated with a fourth polarity different from the first polarity, the second polarity and the third polarity, the separation means being arranged so as to completely separate the terminals from each other.

The invention and its different applications will be better understood upon reading the following description and upon examining the accompanying figures.

### BRIEF DESCRIPTION OF THE FIGURES

The figures are set forth by way of indicating and in no way limiting purposes of the invention.

FIG. 1A to FIG. 1E show an insulating protection according to one embodiment of a first aspect of the invention.

FIG. 2A to FIG. 2D and FIG. 3 show an insulating protection according to one embodiment of a second aspect of the invention.

FIG. 4 shows an assembly according to one embodiment of the second aspect of the invention.

FIG. 5 shows an assembly according to one embodiment of the second aspect of the invention.

### DETAILED DESCRIPTION

Unless otherwise specified, a same element appearing in different figures has a single reference.

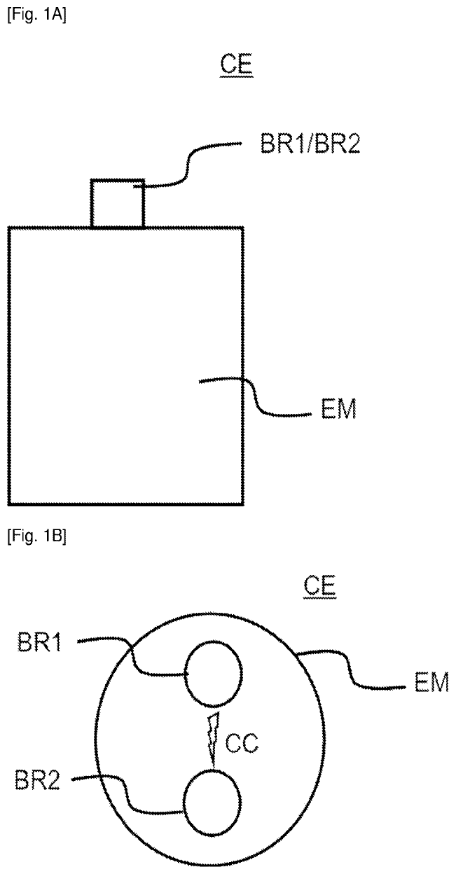

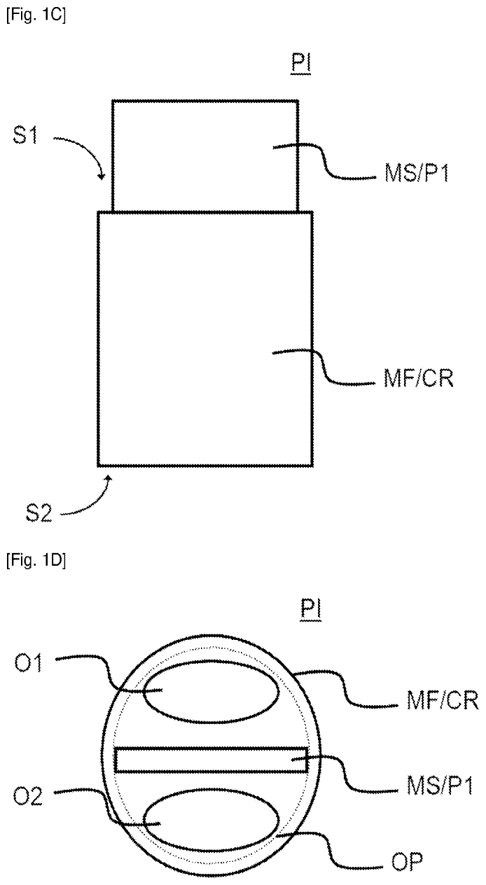

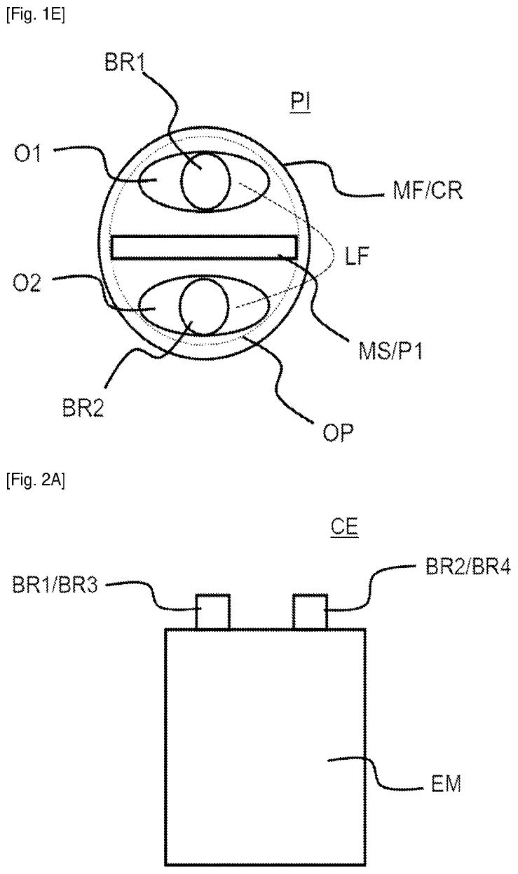

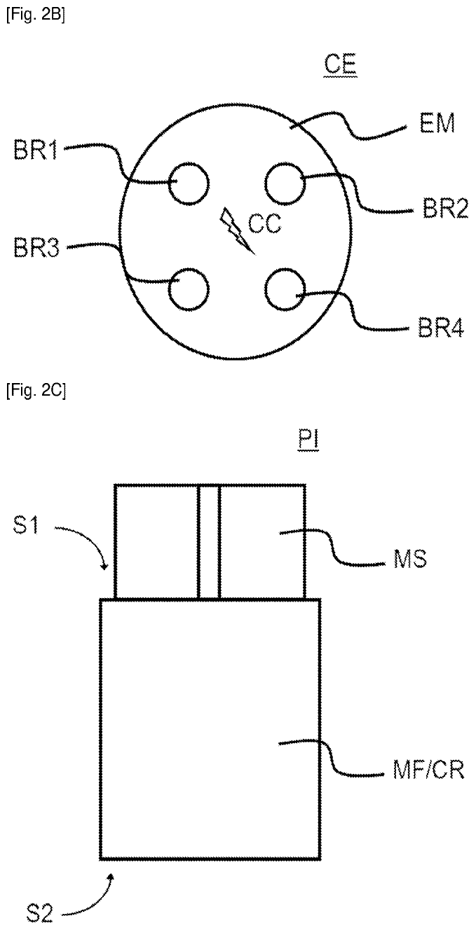

A first aspect of the invention illustrated in FIG. 1A to FIG. 1E relates to an insulating protection PI to be secured to an electrical connector CE. Generally speaking, as illustrated in FIG. 1A (side view) and FIG. 1B (top view), the electrical connector CE comprises a receptacle EM, at least a first terminal BR1 (to be associated with a first polarity) and a second terminal BR2 (to be associated with a second polarity different from the first polarity), the first terminal BR1 and the second terminal BR2 preferably protruding from the receptacle EM. Of course, as will be detailed hereinafter, the electrical connector CE may comprise additional terminals BR3, BR4 (see FIG. 2A and FIG. 2B introduced hereinafter). In such an electrical connector CE, when too high a voltage is applied between the first terminal BR1 and the second terminal BR2, there is a risk of a DC short-circuit (or partial discharge), this risk being even greater at altitude. The insulating protection PI according to the invention is designed especially to reduce or even eliminate this risk.

To this end, as illustrated in FIG. 1C (side view) and FIG. 1D (top view), the insulating protection PI according to the invention comprises an attachment means MF configured so that it can be secured to the electrical connector CE so as to at least partially cover the receptacle EM. By covering the receptacle in this way, the insulating protection PI according to the invention makes it possible to reduce or even eliminate the risk of a short-circuit between a terminal BR1/BR2 of the electrical connector CE and the receptacle EM, which is generally at ground potential. The insulating protection PI according to the invention also comprises an insulating separation means MS arranged so as to completely separate the first terminal BR1 from the second terminal BR2 when the insulating protection PI is secured to the electrical connector CE. It is this separation means MS which will reduce or even eliminate the risks of DC short-circuit between the terminals BR1/BR2 discussed previously. In one embodiment, the insulating protection PI is manufactured, at least partly (for example the separation means MS and/or the attachment means MF), from an insulating material selected from Polyarylamide (also known by the acronym PAA), Polyamide (also known by the acronym PA66), Polysulfone (also known by the acronym PSU), PEEK GLx. The attachment means MF and the separation means MS are distinct from each other.

More particularly, in the embodiment illustrated in FIG. 1C and FIG. 1D, the attachment means MF comprises a hollow body CR, preferably a hollow cylinder CR (for example a circular straight cylinder as illustrated in the figures), of insulating material comprising a first apex S1 and a second apex S2 opposite to the first apex. The hollow body CR thus comprises a cylindrical wall comprising a cylindrical inner surface defining the hollow and a cylindrical outer surface. Finally, the hollow body CR comprises an outer surface radial to the first apex S1. The insulating separation means MS extends outwardly from this outer surface, that is, in the opposite direction to the second apex S2 of the hollow body. In addition, the hollow body CR comprises, at the first apex S1, a first opening O1 and a second opening O2, the first opening O1 being for receiving the first terminal BR1 and the second opening O2 being for receiving the second terminal BR2. It also comprises, at the second apex S2, a main opening OP for receiving the receptacle EM so that the receptacle EM is at least partly inserted into the hollow body CR when the insulating protection PI is secured to the electrical connector CE. Furthermore, in this embodiment, the separation means MS comprises a plate P1 of insulating material in contact with the first apex S1 and disposed perpendicularly to the surface of this first apex S1 between the first opening O1 and the second opening O2 (in other words, the projection of the plate P1 on the first apex S1 forms a line located between the first opening O1 and the second opening O2 and completely separates the two openings O1/O2). This embodiment is particularly suitable for electrical connectors CE intended for single-phase applications, for which a first terminal BR1 corresponds to the phase and a second terminal BR2 corresponds to the neutral. In one embodiment, the thickness of the plate P1 is greater than or equal to 1 mm in order to ensure good mechanical strength, especially with regard to vibrations. In one embodiment, the hollow body CR comprises a thread at the main opening OP, so as to be able to screw the insulating protection PI onto the receptacle EM of the electrical connector CE. The plate P1 of insulating material extends outwardly from the surface of the first apex S1 in the opposite direction to the second apex. The separation means MS thus comprises only at least one plate P1 (that is, only plates) extending outside the hollow body from an outer surface of the apex of the hollow body. The plates comprise at least one radial free edge connecting two free surfaces and a free edge forming an apex of the plate.

As illustrated in FIG. 1E, once the insulating protection PI has been mounted to the electrical connector CE, in addition to limiting the risk of a DC short-circuit, the separation means MS makes it possible to increase length of the creepage distance LF between the first terminal BR1 and the second terminal BR2, the length of this creepage distance LF being able to be modulated using the separation means MS, especially by varying the dimensions thereof.

In a second embodiment illustrated in FIG. 2A and FIG. 2D, the electrical connector CE comprises a receptacle EM, a first terminal BR1 (to be associated with a first polarity), a second terminal BR2 (to be associated with a second polarity different from the first polarity), a third terminal BR3 (to be associated with a third polarity different from the first and second polarities) and a fourth terminal BR4 (to be associated with a fourth polarity different from the first, second and third polarities), said terminals BR1-BR4 protruding from the receptacle EM. In this embodiment, the insulating protection PI is configured to limit or even eliminate the risk of a DC short-circuit between the four terminals BR1-BR4 or between the terminals BR1-BR4 and the receptacle EM of the electrical connector CE, said receptacle EM generally being connected to the mechanical ground of the chassis which supports it.

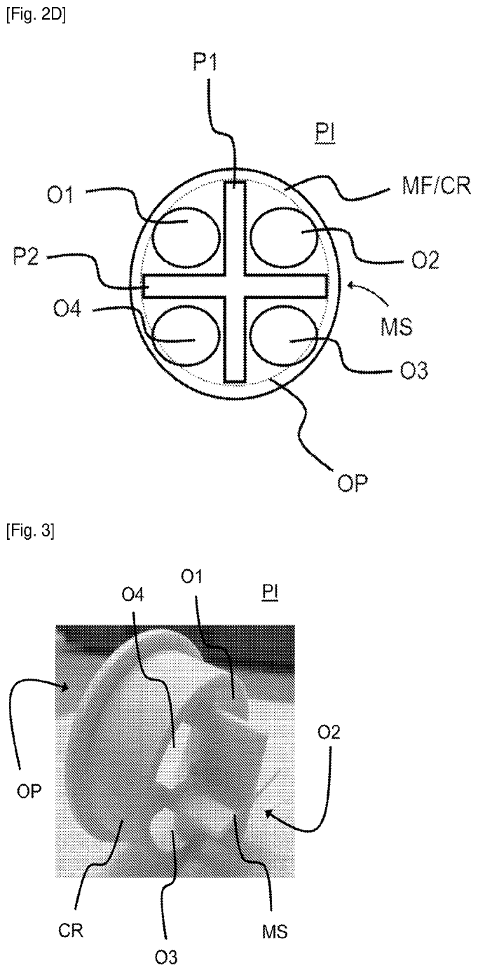

For this, in this embodiment, as illustrated in FIG. 2C and FIG. 2D, the attachment means MF comprises a hollow body CR, preferably a hollow cylinder CR (for example a circular straight cylinder as illustrated in the figures) comprising a first apex S1 and a second apex S2 opposite to the first apex S1. In addition, the hollow body CR comprises, at the first apex S1, a first opening O1, a second opening O2, a third opening O3 and a fourth opening O4, the first opening O1 being for receiving the first terminal BR1, the second opening O2 being for receiving the second terminal BR2, the third opening O3 being for receiving the third terminal BR3 and the fourth opening O4 being for receiving the fourth terminal BR4. It also comprises, at the second apex S2, a main opening OP for accommodating the receptacle EM so that the receptacle EM is inserted, at least partly, into the hollow body CR when the insulating protection is secured to the electrical connector CE. Furthermore, in this embodiment, the separation means MS comprises a first plate P1 of insulating material, said first plate P1 being in contact with the first apex S1 and disposed perpendicularly to the surface of this first apex S1 between the first opening O1 and the second opening O2 on the one hand, and the fourth opening O4 and the third opening O3 on the other hand. The separation means MS also comprises a second plate P2 of insulating material, said second plate P2 being in contact with the first apex S1 and disposed perpendicularly to the surface of this first apex S1 between the first opening O1 and the fourth opening O4 on the one hand, and the second opening O2 and the third opening O3 on the other hand. This embodiment is particularly suitable for electrical connectors CE intended for three-phase applications, where three terminals are each associated with one phase and a fourth terminal is associated with the neutral. An illustration of an insulating protection PI according to this embodiment manufactured by additive manufacturing is illustrated in FIG. 3.

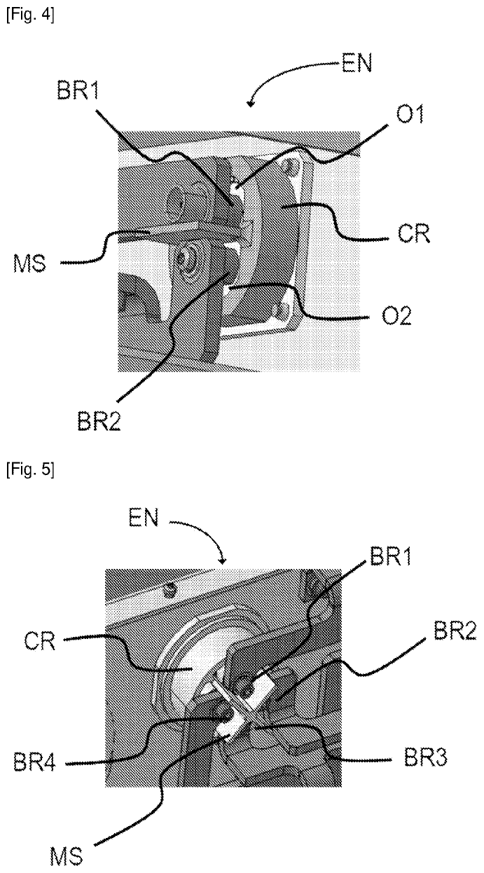

A second aspect of the invention illustrated in FIG. 4 and FIG. 5 relates to an assembly EN comprising an insulating protection PI according to a first aspect of the invention and an electrical connector CE. In one embodiment illustrated in FIG. 4, the electrical connector CE includes a receptacle EM, a first terminal BR1 associated with a first polarity and a second terminal BR2 associated with a second polarity different from the first polarity. A first electrical trace (electrically conductive bar) is connected to the first terminal BR1 and a second electrical trace is connected to the second terminal BR2. Each of the two traces can thus extend perpendicularly to the plates and extend radially outwardly in parallel from the outer surface. In addition, the first terminal BR1 and the second terminal BR2 protrude from the receptacle EM. Besides, the insulating protection PI according to a first aspect of the invention is mounted to the electrical connector CE so that the separation means MS completely separates the first terminal BR1 from the second terminal BR2 (in other words, no part of the first terminal BR1 faces any part of the second terminal BR2). Preferentially, the separation means MS includes a plate P1 as described previously separating the first terminal BR1 from the second terminal BR2. Preferentially, the separation means MS is dimensioned so that the creepage distance between the first terminal BR1 and the second terminal BR2 is greater than a threshold length selected based on the restrictions of use (especially the altitude of use), for example a threshold length greater than or equal to 5 cm, or even greater than or equal to 10 cm.

In one embodiment illustrated in FIG. 5, the electrical connector CE further includes a third terminal BR3 associated with a third polarity different from the first and second polarities, and a fourth terminal BR4 associated with a fourth polarity different from the first polarity, the second polarity and the third polarity. A third electrical trace (electrically conductive bar) is connected to the third terminal BR and a fourth electrical trace is connected to the fourth terminal BR4. As can be seen, the traces are accessible and each comprise a part which extends perpendicularly to the plates forming the separation means MS. In addition, in this embodiment, the insulating protection PI is mounted to the electrical connector CE so that the separation means MS completely separates the terminals BR1-BR4 from each other. Preferentially, the separation means MS includes a first plate P1 and a second plate P2 as described previously separating the terminals BR1-BR4 from each other. Preferentially, the separation means MS is dimensioned so that the creepage distance and/or the insulation distance between two terminals BR1-BR4 is greater than a threshold length selected based on the restrictions of use (especially the altitude of use or the voltage level), for example a threshold length greater than or equal to 5 mm, or even greater than or equal to 10 mm.

1. An insulating protection comprising an attachment means and a separation means, wherein:
the attachment means comprises a hollow body of insulating material including a first apex and a second apex opposite to the first apex, and:
at the first apex comprising a first surface, a first opening and a second opening;
at the second apex, a main opening;
the separation means comprises a plate of insulating material in contact with the first apex and disposed perpendicularly to a surface of the first apex between the first opening and the second opening.

2. The insulating protection according to claim 1, wherein:
the attachment means comprises, at the first apex, a third opening and a fourth opening;
the separation means comprises a second plate of insulating material, said second plate being in contact with the first apex and disposed perpendicularly to the surface of the first apex between the first opening and the fourth opening on the one hand, the second opening and the third opening on the other hand, the first plate of insulating material being disposed between the first opening and the second opening on the one hand, and the fourth opening and the third opening on the other hand.

3. The insulating protection according to claim 1, wherein the insulating protection is manufactured from a material selected from Polyarylamide, Polyamide, Polysulfone, PEEK GLx.

4. An assembly comprising an insulating protection according to claim 1 and an electrical connector, the electrical connector including a receptacle, at least a first terminal associated with a first polarity and a second terminal associated with a second polarity different from the first polarity, the first terminal and the second terminal protruding from the receptacle, the attachment means of the insulating protection being secured to the electrical connector so as to at least partially cover the receptacle and the separation means of the insulating protection being arranged so as to completely separate the first terminal from the second terminal.

5. The assembly according to claim 4, wherein:
the attachment means comprises, at the first apex, a third opening and a fourth opening;
the separation means comprises a second plate of insulating material, said second plate being in contact with the first apex and disposed perpendicularly to the surface of the first apex between the first opening and the fourth opening on the one hand, the second opening and the third opening on the other hand, the first plate of insulating material being disposed between the first opening and the second opening on the one hand, and the fourth opening and the third opening on the other hand, and
wherein the electrical connector includes a third terminal associated with a third polarity different from the first and second polarities, and a fourth terminal associated with a fourth polarity different from the first polarity, the second polarity and the third polarity, the separation means being arranged so as to completely separate the terminals from each other.

6. The assembly according to claim 4, wherein the separation means of the insulating protection is dimensioned such that a creepage distance and the insulation distance between any two terminals of the electrical connector is greater than a threshold length.

7. The assembly according to claim 6, wherein the threshold length is greater than or equal to 5 mm.
